(19) United States
(12) Patent Application Publication
(10) Pub. No.: US 2009/0049023 A1
(43) Pub. Date: Feb. 19, 2009

(54) Method and computer program for collaborative web searching

(75) Inventors: Rajat R. Mittal, Arlington, TX (US); Jeremy A. Forsberg, Bedford, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Board of Regents, The University of Texas System, Austin, TX (US)

(21) Appl. No.: 11/891,772

(22) Filed: Aug. 13, 2007

(51) Int. Cl. G06F 17/30

(52) U.S. Cl. 707/4; 707/E17.014

(57) ABSTRACT

A method and computer program are provided for collaboratively searching one or more distributed computer systems using a web-based user-interface on a computer system. At least a portion of the search processing is remotely performed on the one or more distributed computer systems. The method and computer program include presenting a web-based user interface to a user having one or more search parameters, receiving one or more of the search parameters from the user interface, generating a search request containing the received one or more search parameters, transmitting the search request to at least one other computer system, receiving a search response from the at least one other computer system containing one or more search results from the another computer system, and a sixth computer code for displaying the search results on the user interface.

### REFERENCE TO COMPUTER PROGRAM LISTING APPENDIX

The present application includes a computer program listing appendix. A compact disc entitled “COPY 1” was created on Aug. 10, 2007 and contains the program code of a non-limiting embodiment of the present invention. The compact disc has one ASCII text file entitled “program-code.txt” that is 271 kilobytes in length. The entire contents of the compact disc is hereby incorporated by reference.

### BACKGROUND OF THE INVENTION

1. Field of the Invention

The present invention relates to web searching and, more particularly, to a method and computer program for collaborative web searching.

2. Discussion of the Background

Several databases are known in the prior art that are used to collect information relating to expertise, market needs, or resources. For instance, a community of science and clearing houses were established from Federal and state governments or industry driven initiatives for the purpose of collecting such information. However, these systems include, inter alia, the following inherent deficiencies: (1) data is disconnected from the authentication source (owner/author/university of the data); (2) data collection lacks standardization; (3) overall informational needs are not collectively addressed; (4) sites are promoted to different constituencies allowing for duplication and reducing interaction; and (5) individuals lack a vested interest to keep a third party application, or central databases up-to-date.

Thus, as noted above, there currently exists deficiencies in web searching in the prior art.

### SUMMARY OF THE INVENTION

Accordingly, one aspect of the present invention is to provide a computer program embodied on a computer readable medium for collaboratively searching one or more distributed computer systems using a web-based user-interface on a computer system. At least a portion of the search processing is remotely performed on the one or more distributed computer systems. The method includes a first computer code for presenting a web-based user interface to a user having one or more search parameters, a second computer code for receiving one or more of the search parameters from the user interface, a third computer code for generating a search request containing the received one or more search parameters, a fourth computer code for transmitting the search request to at least one other computer system, a fifth computer code for receiving a search response from the at least one other computer system containing one or more search results from the another computer system, and a sixth computer code for displaying the search results on the user interface.

Another aspect of the present invention is to provide a method for collaboratively searching one or more distributed computer systems using a web-based user-interface on a computer system. At least a portion of the search processing is remotely performed on the one or more distributed computer systems. The method and computer program include presenting a web-based user interface to a user having one or more search parameters, receiving one or more of the search parameters from the user interface, generating a search request containing the received one or more search parameters, transmitting the search request to at least one other computer system, receiving a search response from the at least one other computer system containing one or more search results from the another computer system, and displaying the search results on the user interface.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a block diagram illustrating the current model of collaboration that is known in the prior art;

FIG. 2 is a block diagram illustrating an improved model of collaboration according to an embodiment of the present invention;

FIG. 3A is an exemplary diagram illustrating the often complex design of an academic structure;

FIG. 3B is an exemplary diagram illustrating an improved model according to an embodiment of the present invention;

FIG. 4 is a flow diagram illustrating the high level overall functionality according to an embodiment of the present invention;

FIGS. 5A-5E are flow charts illustrating the overall functionality according to an embodiment of the present invention;

FIG. 6 is an exemplary XML DTD which defines XML tags used to pass search parameters to a partner web server according to an embodiment of the present invention;

FIG. 7 is an exemplary XML DTD which defines XML tags used to pass search results from a partner according to an embodiment of the present invention;

FIG. 8 is an XML file containing search parameters according to an embodiment of the present invention;

FIG. 9 is an XML file containing search results according to an embodiment of the present invention;

FIGS. 10-13 illustrate an exemplary computer program for collaborative web searching according to an embodiment of the present invention;

FIGS. 14 and 15 are block diagrams illustrating a high-level collaborative relationship between one or more partners and a partnership according to an embodiment of the present invention;

FIG. 16 is a block diagram illustrating a collaborative relationship according to an optional embodiment of the present invention;

FIG. 17 is a block diagram illustrating a collaborative relationship according to an optional embodiment of the present invention;

FIG. 18 is a flow chart illustrating the overall functionality for multiple partnerships and sub-partnerships according to an alternate embodiment of the present invention; and

FIGS. 19A-19C are flow charts illustrating the overall functionality relating to funding opportunities according to an embodiment of the present invention.

### DETAILED DESCRIPTION THE PREFERRED EMBODIMENTS

Referring now to the drawings, wherein like reference numerals designate identical or corresponding parts throughout the several views, preferred embodiments of the present invention are described.

The present invention relates to an online portal and mechanism for individuals to search the web using a non-centralized database in which data is retrieved from the source where the information resides. Such a configuration eliminates or at least reduces the actual transfer of data from the source of the information.

The “clustering” of industry, technology and intellectual assets is useful in driving economic development and maintaining a competitive edge in the global marketplace. The present invention enables a new model of interaction by providing an infrastructure and mechanisms which improves the clustering model: (i) by speeding the movement of new ideas into the marketplace; (ii) knowing what expertise and resource exist and their geographic proximity to one another; and (iii) allowing individuals to find each other, form partnerships and solve problems together.

In one possible non-limiting implementation, the online portal and mechanism may be used by individuals throughout academia, industry and state or Federal government(s) to find and build relationships for pursuing sponsored funding, conducting and collaborating in research, creative, and scholarly activities, and maximizing commercialization opportunities. It is to be understood that although one possible implementation of the present invention is academia, the present invention is not limited to academia. The present invention empowers individuals to know the extent and location of expertise and resources while allowing collaborators, including without limitation state and Federal governmental agencies, chambers of commerce, businesses and cities, to build strategies and partnerships within their own regions and enhance the economic interests of the communities they serve.

Locating expertise or resources at a university is very difficult. Often, faculty are unaware of the expertise or resources within their own college, let alone their university that is available for collaboration or solving problems. This lack of access and information permeates to the students they serve, industry partners and community organizations.

There are many inherent reasons why a poor information environment currently exists in Academia:

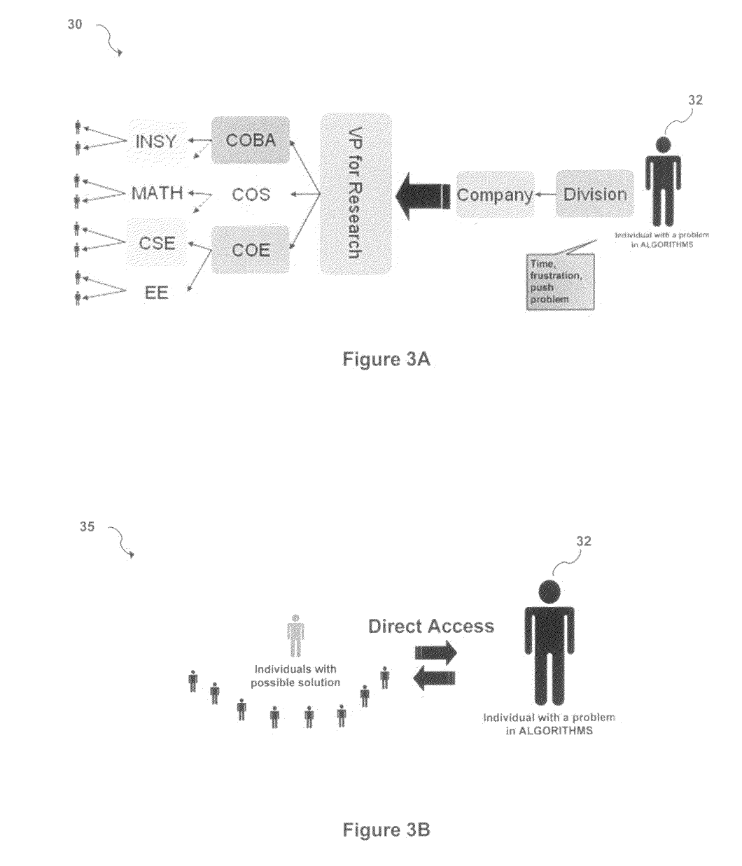

(1) The poor information is often the result the design of the academic structure. Access to information is hindered by the linear paths built within academic structures. This creates an environment for individuals to operate in isolation without knowing or recognizing the beneficial opportunities they could provide one another. For example, an individual 32 may be interested in a solution to a problem or collaboration opportunities relating to “algorithms,” as illustrated in FIG. 3A. Because of the design of the academic structure, the individual may be required to either hand the issue off or drill down the Web to multiple individuals, colleges or departments. The individual further may be required to depend upon the person the issue is handed off to or acquire an advanced knowledge of the university's structure and which department may contain the solution. This may result in frustration to the individual and wasted time contributing to a poor reflection on the academic environment. An improved model according to an embodiment of the present invention is illustrated in FIG. 3B.

(2) Faculty, departments, and colleges promote self interest and typically diverge into duplicated efforts rather than collaborate to share common data and resources. Individuals and departments go in many directions and lack information standardization, representation, and coordination.

(3) Current methods of interaction used by institutions, departments, state and local governments, and the heads of these organizations are impediments to open communication to form partnerships between individuals to solve problems. Despite these impediments, the public depends on a “top down” approach.

(4) In an academic environment, there is typically a lack of a concerted effort for marketing the resources and capabilities of the university. The form of the content is typically in the form of what individuals have previously done and not what those individuals can do for others or how the other individuals can solve problems.

Poor web content is the result of little vested interest for a faculty member to keep information current and is viewed as another item to consume the faculty member's time. Further complicating this situation is duplicated, out of date, or the complete absence of information available on the university's Web site(s).

As a result of any the above problems or any combination thereof, it is common for expertise or the results of research to be disassociated from the university's faculty server and the geographic location of such expertise. For example, publications, reports, research results and the like are usually disseminated through various mechanisms and locations throughout the Internet.

The present invention includes a tool for organizing web content for easy distribution through the Internet. In one embodiment, the present invention includes without limitation: (1) an information repository which facilitates automatic generation of curriculum vitae, biosketches and other reports; (2) a Web editor which allows authors to update information in real time; (3) an accountability and performance reporting mechanism which facilitates automation for faculty progress reports; and (4) a single location to save faculty time and the vested incentive for faculty to keep expertise and resources within the system current.

The present invention allows for the association of data by any means within a partners computer system and thereby has little to no affect on business practices or the administrative and operational differences between partner, provides the vested interest and ease of use to save time (e.g., individuals use it in their best interest because it saves time), and through data standardization allows for interoperability with various information repositories.

Partners which produce academic and research intellectual products generally have the following common expertise and research/scholarly related resources within their organizations: (i) persons with expertise; (ii) technologies and patents; (iii) research centers; (iv) laboratories and research groups; (v) research facilities; and (v) equipment. The present invention allows these resources and others to be easily available on each partner's respective website for public consumption and collaboration. By establishing a few “core” data standards common for each resource, the present invention can identify, search and associate these resources into a virtual storefront for individuals to freely access.

In one embodiment, the present invention organizes information using a collaborative data dictionary. The collaborative data dictionary (“CDD”) is a data schema used to define and link research resources common among partners. The CDD uses a standard of data elements to link databases, search engines, or systems located within the partner's computer system. In one embodiment, each partner maintains its own data, business practices and security without any data being stored in the partnership.

The present invention includes downloadable tools and documentation to assist in connectivity between the participating partner. Technically, this process does not require any additional hardware for the participating partner. CDD utilizes and is compatible with the Federal government's “SF 424” core data elements (available at http://www.grants.gov/) and the Dublin core Metadata standards.

If a partner's expertise or resources are already stored in a database (or multiple databases throughout their enterprise), the translation or mapping may be mapped to the CDD schema to the databases. The common data elements may then be translated to the CDD. Once complete, the partner may either create an internal search or provide read-only access to the partner's data such that the search may be initiated external to the partner. The partner is then included as a participating member of the partnership and all or at least some of its resources are searchable for collaboration.

If a partner does not currently have their resources (data) meaningfully organized, a profile system may be employed. The profile system of the present invention is flexible and adaptable to a partner's business practices, security requirements, process and the like, and provides the partner control of its own information while reducing duplication. Cost savings are realized as employee time, third party vendors, subscriptions and the like are eliminated or minimized.

A shared service of the profile system can be centrally housed allowing any partner to simply have individuals, such as faculty, centers, department employees and the like, elect to use the present invention as the individual deems appropriate. Again, individuals choose to use the profile system because of its ease of use and multiple features to save them time. Each individual may remotely authenticate themselves to gain access to update their profile.

All of the above may be used to connect and associate expertise and resources with little to no resistance of the partner. The information is always live and current because it utilizes the authentication and business practices of the partner. As information is updated at any webpage or website, the present invention may be configured to maintain a connection in real time to the most current information of the partner.

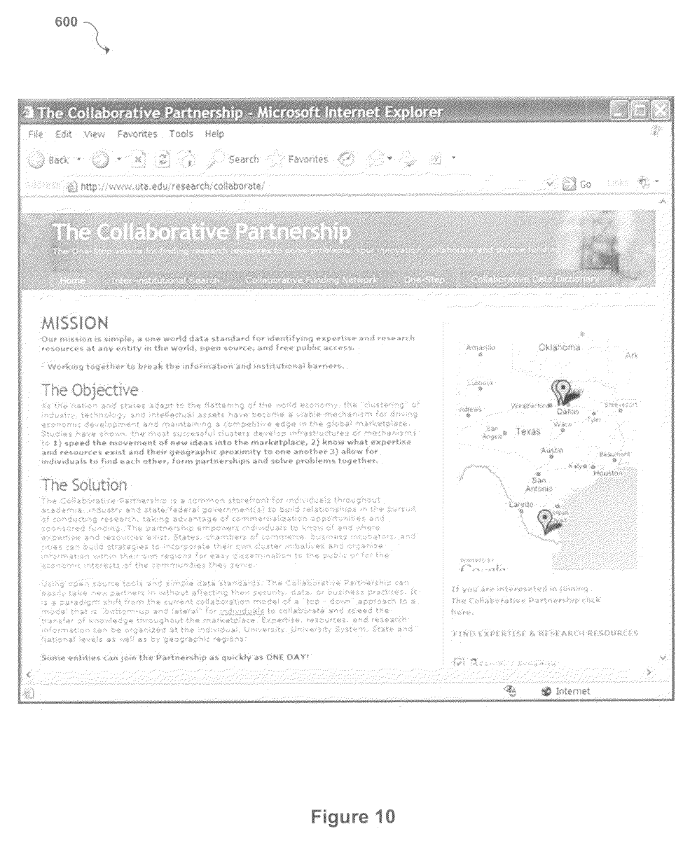

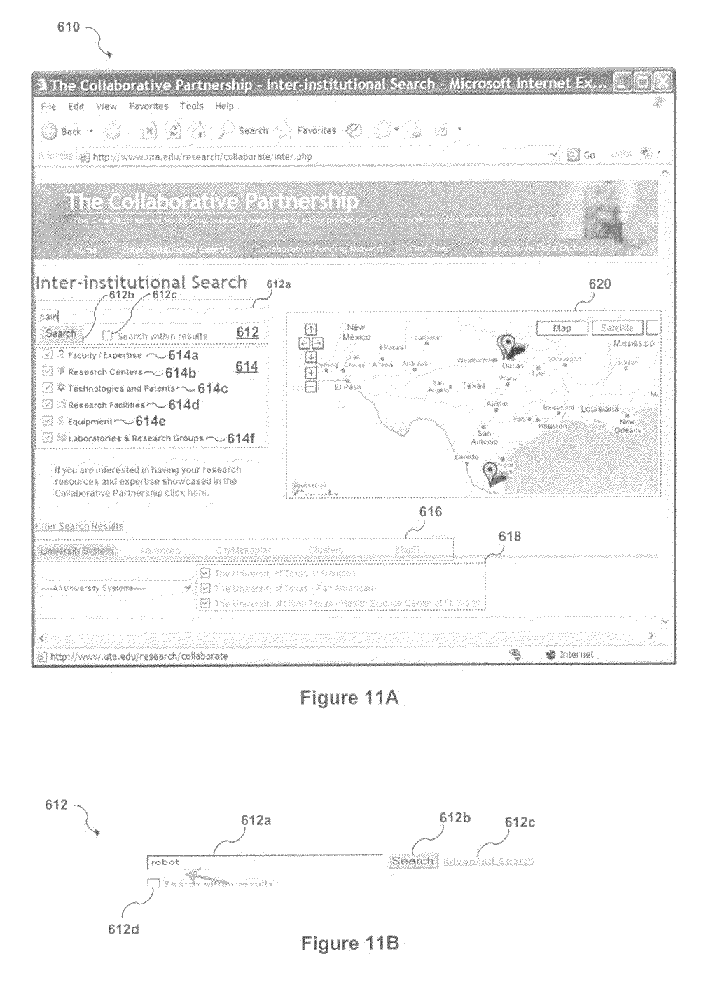

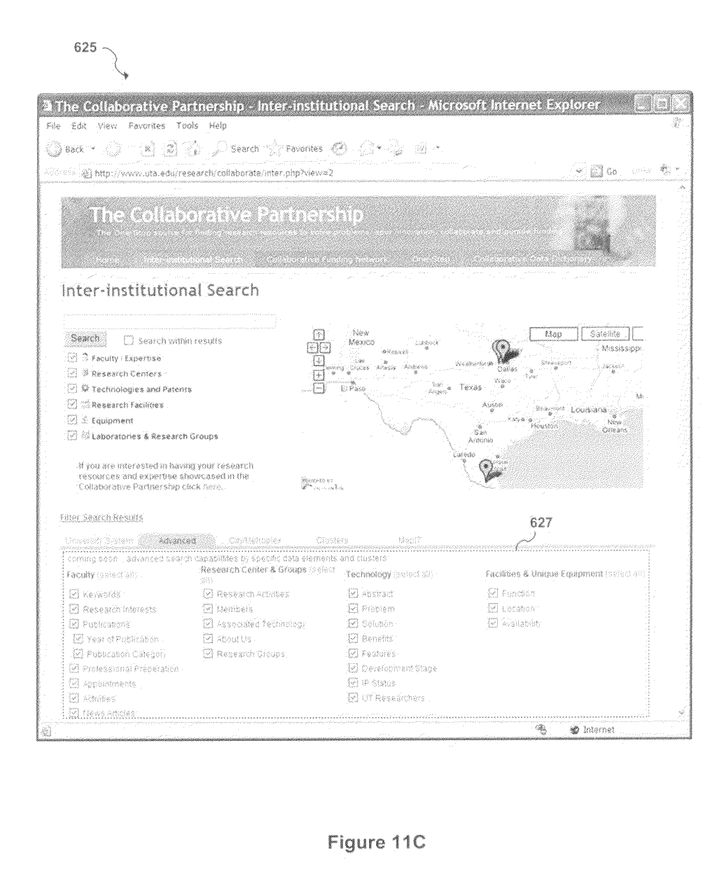

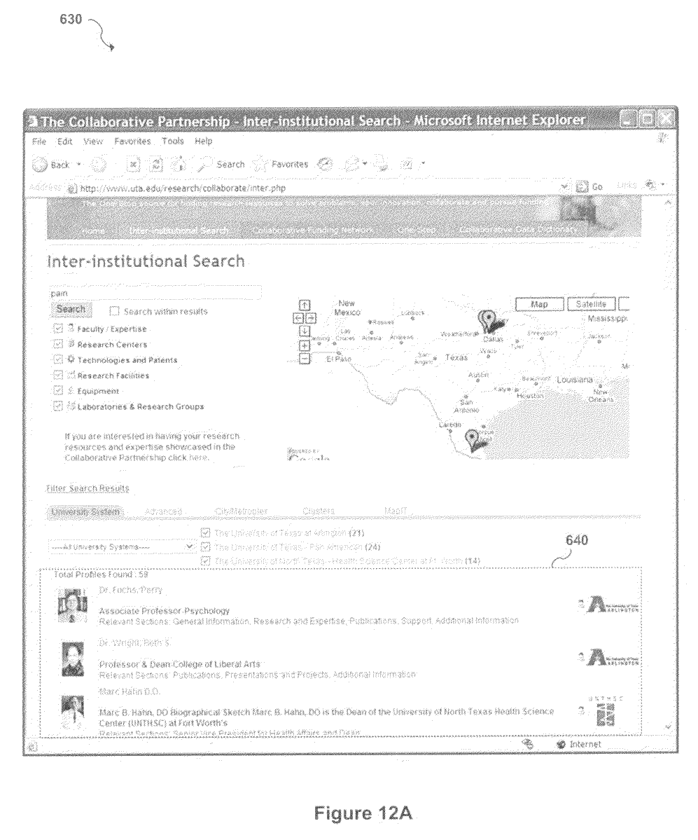

A non-limiting example of an implementation of the present invention may be viewed at “http://www.uta.edu/research/collaborate/,” as shown in FIGS. 10-13. As shown in FIGS. 12A and 12B, a keyword search, such as “pain”, will result in related expertise and resources from the partners currently in the partnership. As shown in FIG. 11A, the locations of the search results may be configured to be plotted geographically on map area 620 using the Google Maps API or the like. The search results include multiple institutions, departments, disciplines and potential opportunities in one place. The search may also utilize advanced filtering options. For instance, as shown the advance search filter area 627 of FIG. 11C, a search may be filtered based on, without limitation, keywords, research interests, publications, professional preparation, etc.

In one embodiment of the present invention, each partner has electronic access to the resources and search results of each of the other partners of the partnership. Each partner has the ability to use its own customized home page for searching partnership resources and the ability to rank the order of the search results for its constituents or page visitors as it deems appropriate. For example, a university may configure its own search page (URL) to provide a higher ranking to the search results of the resources and expertise within the university or its local community. Consortia can be formed dynamically between existing partners and new partners.

The collaborative cluster initiative (CCI) is a script of disciplines and keywords to organize the research and scholarly endeavor into meaningful state or market “clusters” as well as Federal sponsor “Roadmap” initiatives. The CCI is used to organize funding opportunities from the CFN and resources and expertise from the CDD into meaningful state and Federal clusters to facilitate inter-disciplinary research and scholarly activities as well as provide a meaningful context to the public. For example the CCI may be used to incorporate the Texas Technology and Industry Clusters as well as a “roadmap” for Homeland Security.

TABLE 1

| | | Home Land Security |
|---|---|---|
| Industry Clusters | Technology Clusters | Roadmap |
| Advanced Manufacturing | Advanced Energy | Awareness and Vulnerabilities |
| | Technologies | |
| Aerospace and Defense | Biotechnology | Prevention and Security |
| Biotechnology and Life | MEMS Technology | Response and Recovery |
| Science | | |
| Energy | Nanotechnologies | Analysis and Social or |
| | | Economic Effects of Attacks |
| | | and National Policy |
| Information and Computer | Semiconductor Technologies | |
| Technology | | |
| Petroleum Refining and | Software | |
| Chemical Products | Technology/Wireless | |

As shown in table 1, a variety of roadmaps and clusters may be developed and refined to make very meaningful funding opportunities or expertise related searches.

Depending upon the level of CDD connectivity, various report and performance metrics may occur in real time. For example, reports on all the publications of a partner's employees in a user defined time frame can be made in real time.

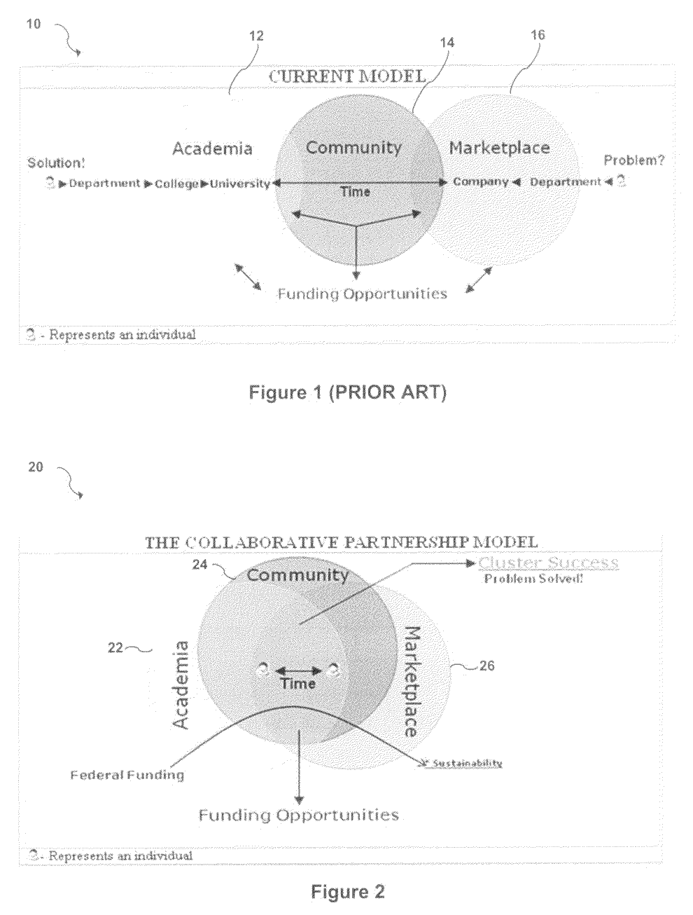

Referring to FIG. 1, a block diagram illustrating the current model of collaboration that is known in the prior art is shown. As shown in FIG. 1, Community 14 represents parties which facilitate economic development, including without limitation the chamber of commerce, city and State governmental agencies, angel investors, business incubators and service centers. Academia 12 represents academia-related parties including without limitation universities, federal laboratories, and community colleges. Marketplace 16 represents business marketplace entities including without limitation high tech companies, start-ups, and business consortia. As shown in FIG. 1, the time involved in solving a problem, such as locating information or data, is high because there is little or no overlap or collaboration between academia 12, the community 14 and the marketplace 16.

Referring to FIG. 2, a block diagram illustrating the model of collaboration according to an embodiment of the present invention is shown. As shown in FIG. 2, Community 24 represents parties which facilitate economic development, including without limitation the chamber of commerce, city and State governmental agencies, angel investors, business incubators and service centers. Academia 22 represents academia-related parties including without limitation universities, federal laboratories, and community colleges. Marketplace 26 represents business marketplace entities including without limitation high tech companies, start-ups, and business consortia. As shown in FIG. 1, the time involved in solving a problem is greatly reduced by the present invention.

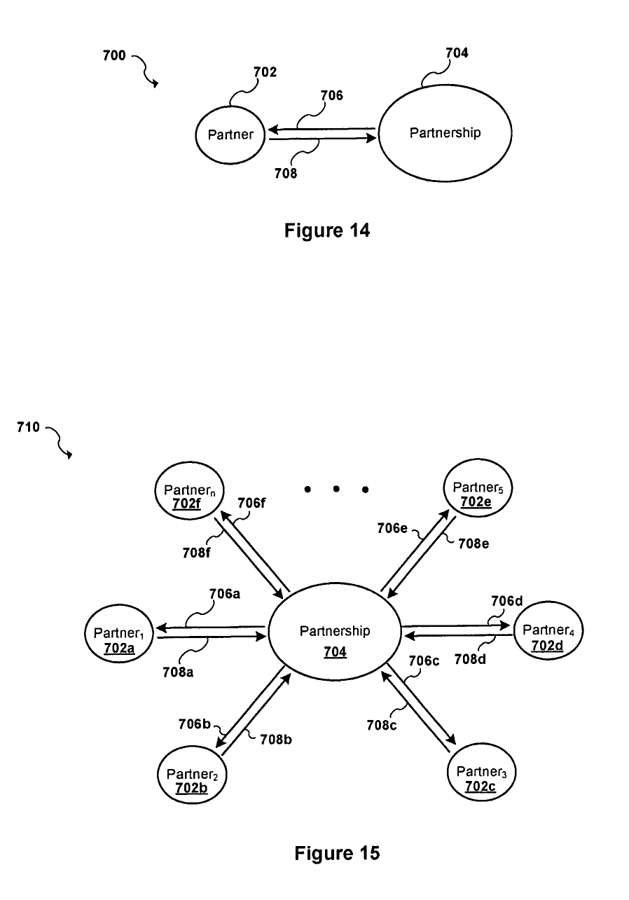

Referring to FIGS. 14 and 15, block diagrams illustrating a high-level collaborative relationship between one or more partners and a partnership according to an embodiment of the present invention are shown. As shown in FIGS. 14 and 15, one or more partner computer systems (702, 702a-702f) are associated with a partnership computer system 704. As is known by one skilled in the art, a computer system may include multiple personal computers, laptops, servers and/or other devices which may be connected together by any means, including, without limitation, a local area network (LAN), a wide-area network (WAN). A computer system may also include both wireless and physical connections between the personal computers, servers and/or other devices.

A user may search one or more partner computer systems (702, 702a-702f) by means of a user interface accessible via partnership computer system 704. In one embodiment, the search itself is processed by the respective partner computer systems (702, 702a-702f) of their computer systems, rather than by the partnership computer system 704. A search request is transmitted by the partnership computer system 704 to one or more partner computer systems (702, 702a-702f), as represented by communications (706, 706a-706f). The search may include without limitation a search of one or more databases 52 located on the partner computer systems (702, 702a-702f). The search may also include without limitation a search of one or more ASCII files, web pages or the like, located on the partner computer systems (702, 702a-702f). Upon completion of the search, the respective partner computer systems (702, 702a-702f) return a search response containing the search results to the partnership computer system 704, as represented by communications (708, 708a-708f). The search results displayed by means of a user interface accessible via partnership computer system 704. In one embodiment, the search results are merged and collectively displayed. Each entry in the search results may include one or more hyperlinks or the like which link to the location of the data on the partner computer systems (702, 702a-702f) such that, upon selection, the user is transferred to the respective partner computer systems (702, 702a-702f) which displays the respective data. Thereby, the search user interface is abstracted from the processing of the search request and the location of the data on one or more partner computer systems (702, 702a-702f). In an alternate embodiment, the processing of the search may be shared between one or more partner computer systems (702, 702a-702f) and the partnership computer system 704, such that at least a portion of the search is processed by the respective partner computer systems (702, 702a-702f).

As described in further detail below, according to one embodiment, initially, upon access of the partnership computer system 704, a user of the partnership computer system 704 is presented with a web-based user interface which allows the user to enter one or more search parameters to find information or data located on one or more partner computer systems (702, 702a-702f). For instance, the user may use a web-browser to access the partnership computer system 704 using a universal resource locator (“URL”). Upon access, a web-server, directly or indirectly associated with the partnership computer system 704, transmits a user interface to the user. Using the user interface, the user search one or more of the partner computer systems (702, 702a-702f) based one or more search parameters selected and/or entered by the user. The partnership computer system 704 generates a search request based on the one or more search parameters, and transmits the search request to one or more of the partner computer systems (702, 702a-702f), as represented by communications (706, 706a-706f). Upon receipt of a search request, the partner computer systems (702, 702a-702f) initiate a search on their respective computer systems based on the search request. Upon completion of the search, the respective partner computer systems (702, 702a-702f) return a search result to the partnership computer system 704, as represented by communications (708, 708a-708f). The partnership computer system 704 parses and displays the search results are parsed in the user interface. In at least one embodiment the search results are sorted in order of relevance to the search parameters. Because the user interface may receive search results from multiple partner computer systems (702, 702a-702f), the search results may be merged based on a relevance score of the search results.

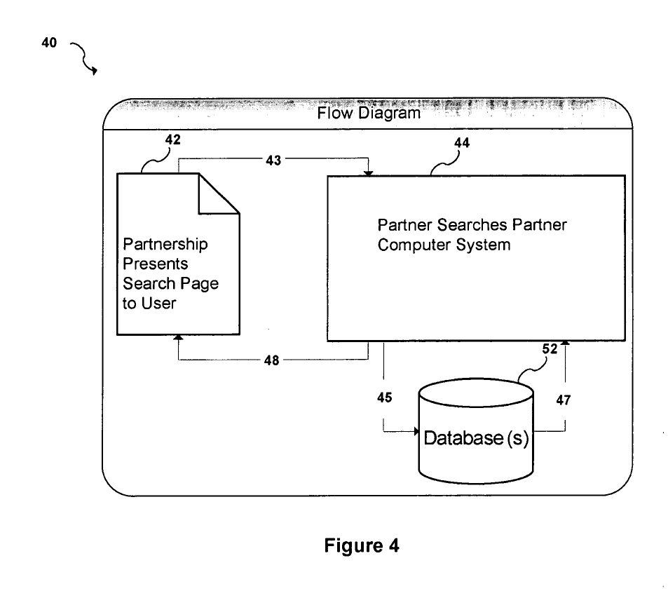

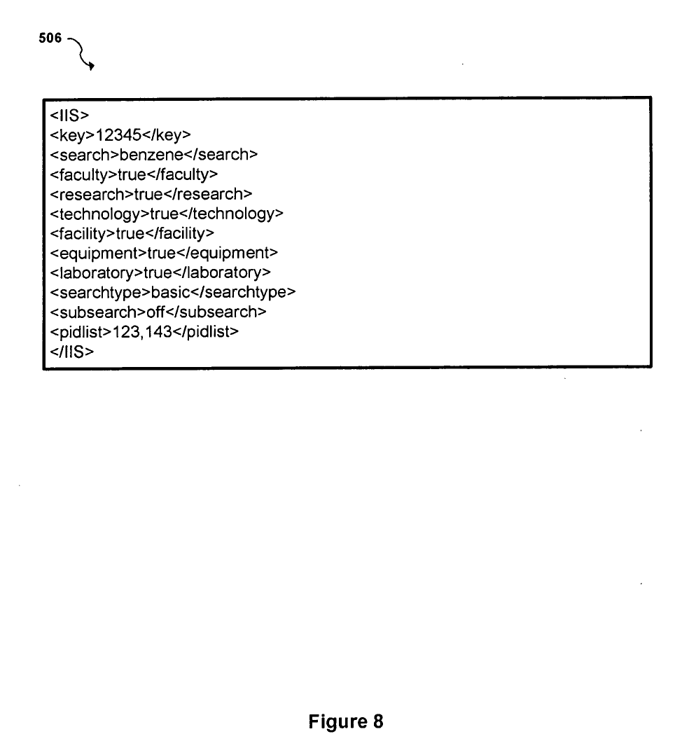

Referring to FIG. 4, a flow diagram illustrating high level overall functionality according to one possible embodiment of the present invention is shown. This flow diagram is shown to provide a non-limiting general understanding of the distributed nature of a user search and is not intended to limit the present invention. As shown at block 42, upon access to partnership computer system 704, a user is presented with a web-based user interface which allows the user to enter one or more search parameters to find information or data located on the computers of one or more partner computer systems (702, 702a-702f). For instance, the user may be presented with user interface 610, shown in FIG. 11A. After the user enters a search term in text field 612a of input area 612 and selects one or more search parameters (614a-614f) of search parameter area 614, the user may choose to search one or more partner computer systems (702, 702a-702f) by selecting search button 612b. The partnership computer system 704 generates a search request and transmits the search request to the partner, as represented by communication 43. As is known by those skilled in the art, a search request may be in any form including, without limitation, an XML file, a HTML file, ASCII text, a binary or otherwise compress file, an encrypted file or the like. A search request may include one or more search parameters. In one possible non-limiting implementation, an XML file, such as XML file 506 shown in FIG. 8, is generated which contains one or more search parameters. For instance, if the user is searching for the search term “benzene,” XML file 506 may be generated by the partnership computer system 704 and transmitted to the respective partner computer systems (702, 702a-702f). It is to be understood that the present invention is not limited to XML file 506 or the use of XML to pass search parameters.

As shown in block 44, upon receipt of the search request, the respective partner computer systems (702, 702a-702f) initiates a search on its computer system based on the search request. For instance, the search may be based the search parameters contained in XML request file 506. The search may include without limitation a search of one or more databases 52 located on the partner computer system (702, 702a-702f). The search may also include, without limitation, a search of one or more ASCII files, web pages, binary or otherwise compress files, encrypted files, password protected files or the like. For instance, the search may include searching one or more databases 52 and receiving search results from the one or more database 52, as represented by communications 45 and 47, respectively. The respective partner computer systems (702, 702a-702f) generates a search result and transmits the search result to the partnership computer system 704, as represented by communication 48.

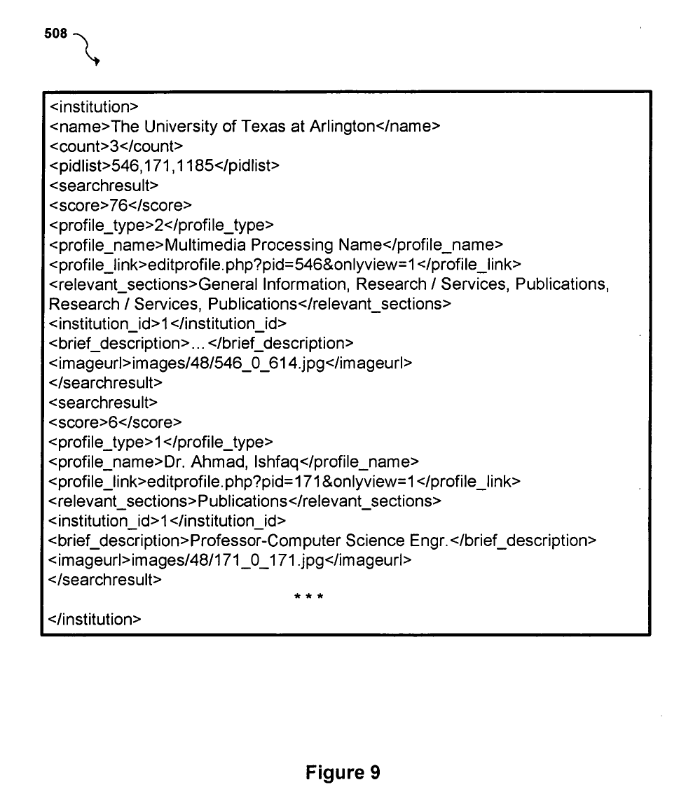

In one possible non-limiting implementation, an XML file, such XML file 508 shown in FIG. 9, is generated which contains the search response. The search response is transmitted back to the partnership computer system 704 where it is parsed and displayed to the user in a web-based user interface. For instance, user interface 630 may be presented to the user which includes the search results, based on the search parameters entered by the user, in search result area 640. In at least one embodiment the search results are sorted in order of relevance to the search parameters. Because the web-based user interface may receive search responses from multiple partner computer systems (702, 702a-702f), the search results may be merged based on a relevance score of the search results. It is to be understood that the present invention is not limited to XML file 508 or the use of XML to pass a search response.

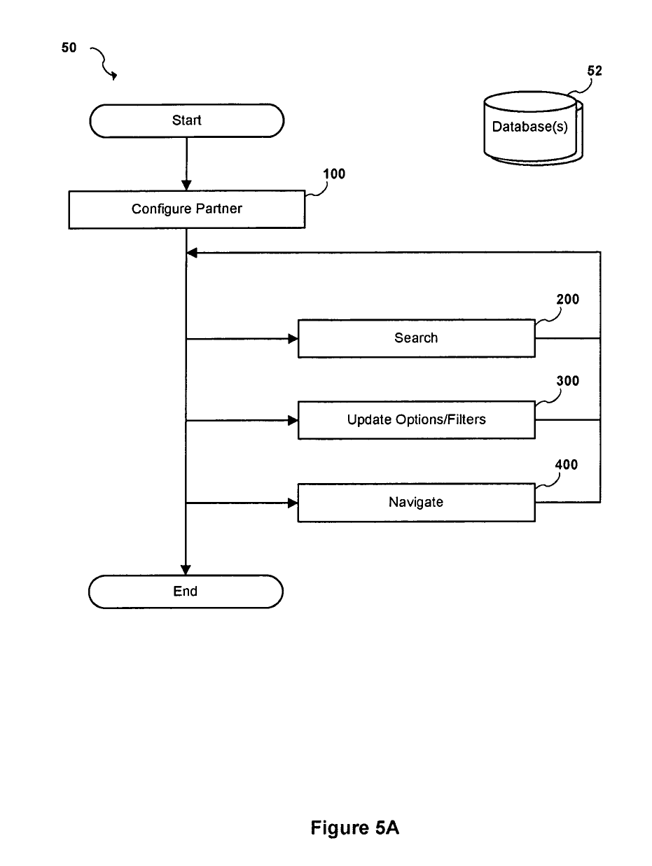

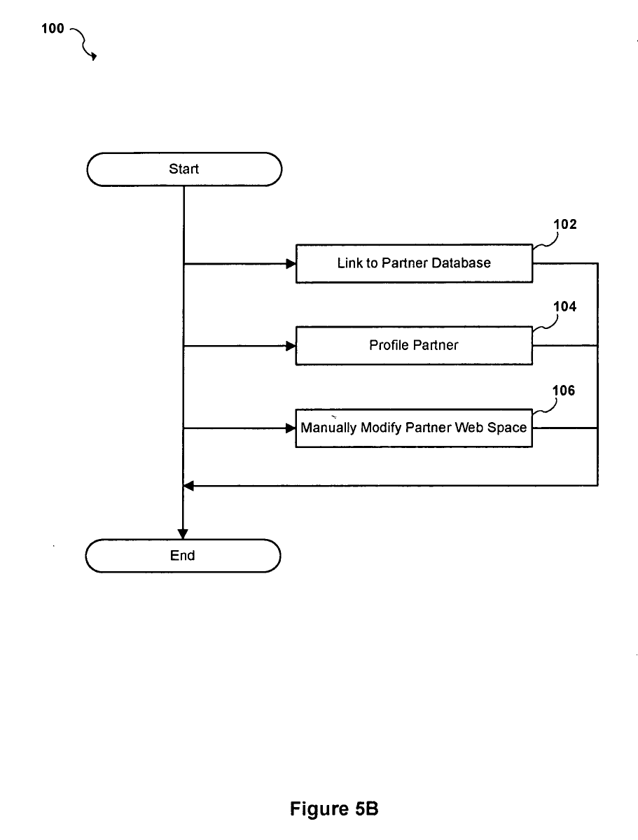

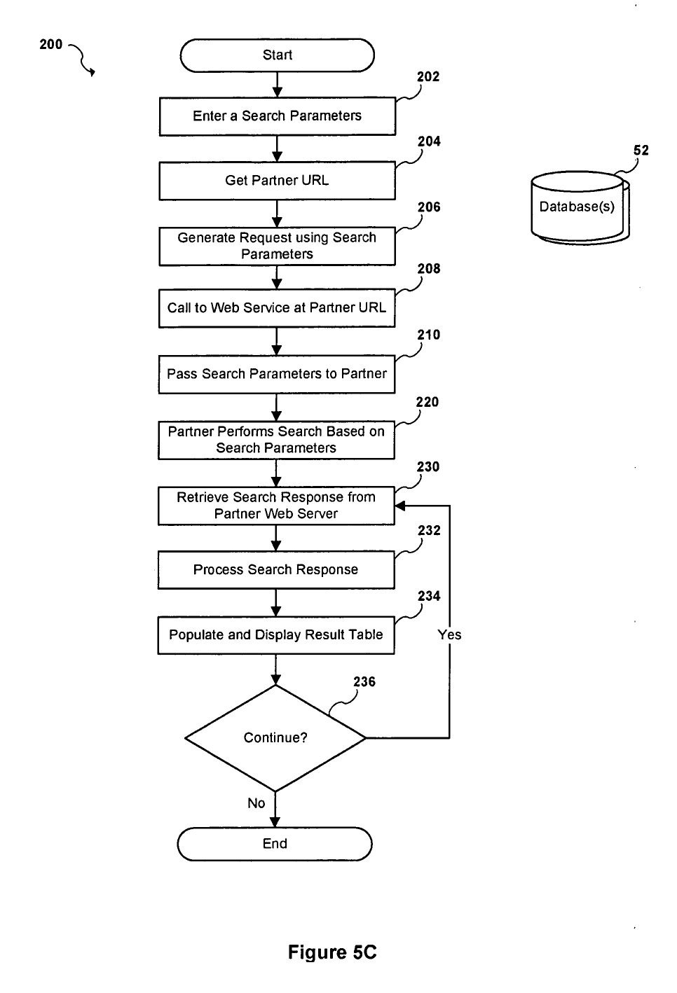

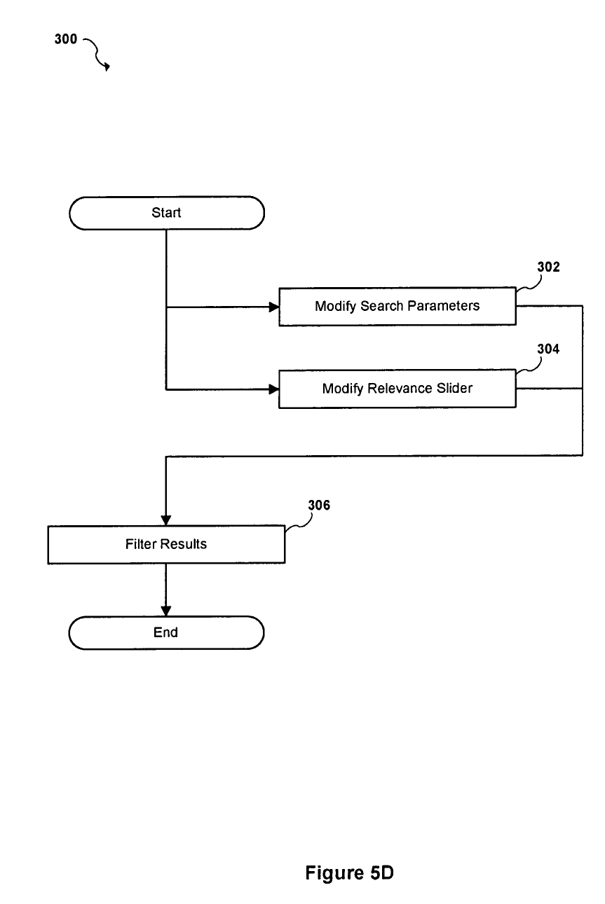

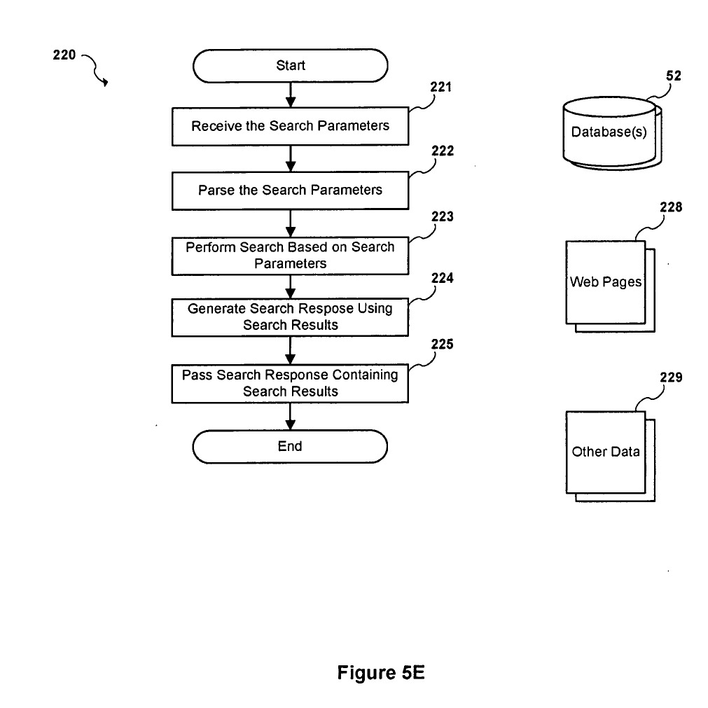

Referring to FIGS. 5A-5D, flow charts illustrating the overall system functionality according to an embodiment of the present invention are shown. As shown at block 100 of FIG. 5A, when a new partner is added to the partnership, the partner computer system (702, 702a-702f) for that partner is initially configured to operate with the present invention. In essence, a partner computer system (702, 702a-702f) is configured to operatively communicate with the partnership computer system 704, such that the partnership computer system 704 may communicate a search request to the partner computer system (702, 702a-702f), and the partner computer system (702, 702a-702f) processes the search requests on behalf of the partnership computer system 704 and communicates a search result back to the partnership computer system 704 for display. For instance, new partner may be configured by configuring a web server on the partner computer system (702, 702a-702f) at a URL to receive the search request from the partner computer system (702, 702a-702f). Upon receipt of the search request, the partner computer system (702, 702a-702f) processes the search request and returns a search result to the partnership computer system 704. The partner computer system (702, 702a-702f) may search, without limitation: (i) one or more databases on the partner computer system (702, 702a-702f), as shown at block 102; (ii) data as profiled on the partner computer system (702, 702a-702f) generated by a profile generator, as shown at block 104; and/or (iii) web pages manually modified to include one or more metatags corresponding to the search parameters, as shown at block 106.

After the new partner is configured to operate with the present invention, a user may either request that a search be performed on one or more partner computer systems (702, 702a-702f) as shown at block 200, update options or filters as shown at block 300 or navigate a search result as shown at block 400.

FIG. 5C describes how a search is performed on one or more partner computer systems (702, 702a-702f) according to one possible embodiment. As shown at block 202, a user enters and/or selects one or more search parameters using a user interface. For instance, the user may be presented with user interface 610 shown in FIG. 11A. After the user enters a search term in text field 612a of input area 612 and one or more search parameters (614a-614f) of search parameter area 614, the user may select search button 612b to search one or more partner computer systems (702, 702a-702f). As shown at block 204, the URL of the web server of the partner computer system (702, 702a-702f) is retrieved from one or more databases 52. A search request, such as an XML file, is generated using the search parameters entered and/or selected by the user, as shown at block 206. In one optional embodiment, a web service is called on the partner computer system (702, 702a-702f), as shown at block 208. As shown at block 210, the search request is passed to the web server of the partner computer system (702, 702a-702f). In one embodiment, the partner computer systems (702, 702a-702f) receives the search request containing the search parameters, as shown at block 221.

After receiving the search request, the partner computer system (702, 702a-702f) performs a search using the search parameters contained therein, as shown at block 220. As shown at block 222, the search request is parsed and the search parameters are extracted. Optionally, the partner computer system (702, 702a-702f) checks the “key” field value and proceeds only if this value matches the key uniquely associated with the partner. The partner computer system (702, 702a-702f) may search one or more databases 52, web pages 228 and/or other data 229 in those sections selected by the user (i.e., those sections which correspond to the search parameters and/or search filters). The one or more databases 52 may include proprietary databases. As shown at block 224, the partner computer system (702, 702a-702f) generates a search response and populates the search response with the search results. As shown in FIG. 9, in one embodiment, each search result is coded with a separate searchresult XML tag which contains values for the “score,” “profile_type,” “profile_name,” “profile_link,” “relevant_section,” “institution_id,” “brief description” and “imageurl” fields as described in more detail below. The search response containing the search results is then transmitted to the partnership computer system 704, as shown at block 225.

As shown at blocks 230 and 232, the search response is received by the partnership computer system 704 and then processed. The search results are populated into a result table, array, or the like, and displayed to the user via a user interface, as shown at block 234. In one embodiment, the search results are displayed according to its relevance. In another embodiment, the top matching results are displayed, such as the top ten. In yet another embodiment, the search results previously viewed by other users for the same keyword search are displayed. In another embodiment, other keyword searches previously performed by other users with the same keyword search are displayed.

In one possible embodiment, the web service is an AJAX connection that is established with the web server of the partner computer system (702, 702a-702f). The partnership computer system 704 may receive and merge search results from multiple partner computer systems (702, 702a-702f) in the same user interface. In one possible embodiment, this may be accomplished using an AJAX connection. However, it is to be understood that the present invention is not limited to using AJAX and that other web services and connection means are known by those skilled in the art.

Blocks 232-234 continue until each of the search results are returned from the selected one or more partner computer systems (702, 702a-702f), as shown at decision block 236. A timeout may also result in termination of blocks 232-234. Depending on the web service, the partnership computer system 704 may need to close or terminate the web service. For instance, optionally, an AJAX connection is closed.

FIG. 5D describes updating options or filters according to one embodiment. A user may either update search parameters, as shown at block 302, or update a minimum relevance value, as shown at block 304. In one embodiment, a relevance slider in relevance area 644 may be adjusted by the user to reflect the minimum relevance value. After the user updates one or more search parameters or the minimum relevance value, the search results displayed in the user interface are filtered, as shown at block 306.

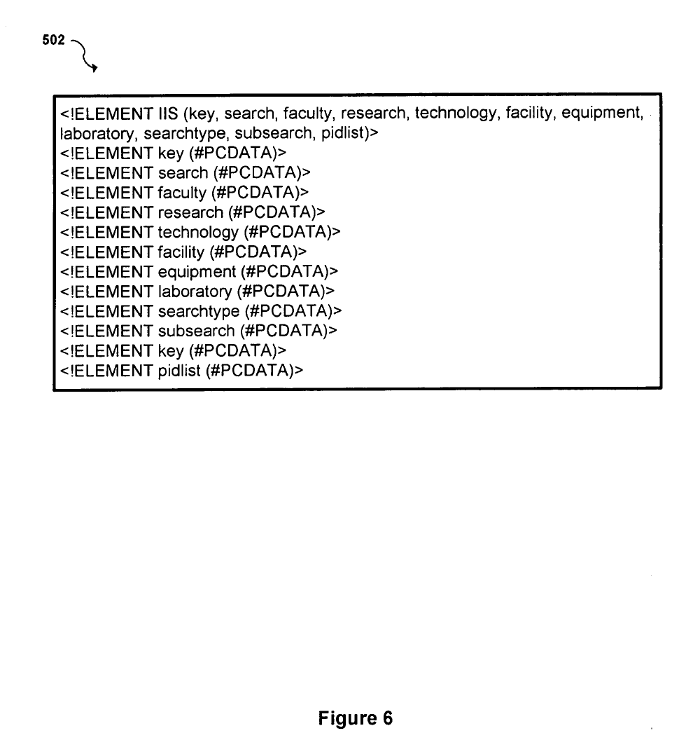

Referring to FIG. 6, an exemplary extensible markup language (“XML”) document type definitions (“DTD”) which defines XML tags used to pass search parameters to the web server of a partner computer system (702, 702a-702f) according to an embodiment of the present invention is shown. An XML DTD that is used to define XML tags used to pass search parameters to the web server of the partner computer system (702, 702a-702f) is referred to throughout this document as the “Request XML DTD.” It is to be understood that the present invention is not to be limited to the XML tags defined in FIG. 6. It is further to be understood that the present invention is not limited to passing search parameters using XML and that, instead, an XML file is only one possible way to transmit search parameters as would be known by one skilled in the art. As shown in FIG. 6, the XML DTD 502 defines “key,” “search,” “faculty,” “research,” “technology,” “facility,” “equipment,” “laboratory,” “searchtype,” “subsearch” and “pidlist” XML tag fields. In one embodiment, the “key” field is a ten character alpha-numeric string that is used to uniquely identify a partner. In another embodiment, the key is an encrypted value in ASCII format that is dynamically generated to uniquely identify the partner. The partner computer system (702, 702a-702f) may use the value of the “key” field to validate or authenticate the search request. The “search” field contains the actual search term that the user entered in the web-based user interface. The “faculty,” “research,” “technology,” “facility,” “equipment” and “laboratory” fields are true/false indicators which indicate the search parameters selected by the user in the web-based user interface. For example, search parameter check boxes (614a-614f) of search parameter area 614 in web-based user interface 610, as shown in FIG. 11A, may be used by the user to select whether the user desires to filter the search based on the respective search parameter. For instance, if the user enters the search term “benzene” in the web-based user interface 610 shown in FIG. 11A and desires to include all of the “faculty,” “research,” “technology,” “facility,” “equipment” and “laboratory” search parameters by selecting each of the respective checkboxes in search parameter area 614, then the XML file 506 shown in FIG. 8 may be generated by the present invention. The “subsearch” field is used to indicate whether the search is with the search result of another search (a sub-search) and may be used by the user to fine-tune the search results. If the “subsearch” field is “on,” then the search is a subsearch. If the “subsearch” field is “off,” then the search is a regular search. The “pidlist” field is used as a unique identifier for the search results. A sub-search includes the pidlist of the prior search in order to identify the search results that should be further searched. In one embodiment, the “pidlist” field may represent a series of unique identifiers for multiple searches. Each unique identifier being comma separated.

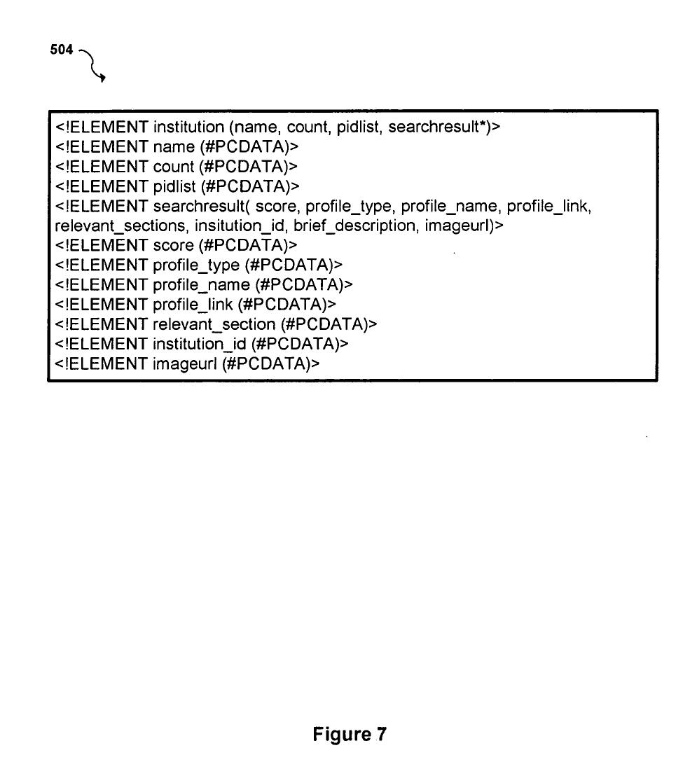

Referring to FIG. 7, an exemplary XML DTD which defines XML tags used to pass search results from a web server of the partner computer system (702, 702a-702f) according to an embodiment of the present invention is shown. An XML DTD that is used to define XML tags used to pass search results from a web server of the partner computer system (702, 702a-702f) is referred to throughout this document as the “Response XML DTD.” It is to be understood that the present invention is not to be limited to the XML tags defined in FIG. 7. It is further to be understood that the present invention is not limited to passing search results using XML and that, instead, an XML file is only one possible way to transmit search results as would be known by one skilled in the art. As shown in FIG. 7, the XML DTD 504 defines “name,” “count,” “pidlist” and “searchresult” XML tag fields. The XML DTD 504 further defines “score,” “profile_type,” “profile_name,” “profile_link,” “relevant_section,” “institution_id,” “brief description” and “imageurl” XML tag fields which are associated with the “searchresult” field. In one embodiment, the “name” field is full name of the partner or institution. The “count” field is the number of records in the search result. The “pidlist” field is a list of unique record identifiers that have been selected for this particular search request. The “seachresult” field contains individuals search result records. The “score” field is the absolute score, also known as the “relevance,” of the search result record. For instance, the “score” field may represent the number of times the search pattern was found in a particular profile. The “profile_type” field is the type of profile for the search result record. The type of profile includes without limitation the profile types shown in table 2 below.

TABLE 2

| Profile Type | Value |
|---|---|
| Faculty | 1 |
| Research Center | 2 |
| Technology | 3 |
| Facilities | 4 |
| Equipment | 5 |
| Laboratories | 6 |

The “profile_name” field is the title for the profile. The “profile_link” field is a hyperlink to the profile of the search result record. The “relevant_section” field is the name of the section(s) where the search pattern was found. The “institution_id” field is a unique identifier for the partner. The “brief description” field is a brief description of the profile for the search result record. The content of the “brief description” field may be restricted to a limited number of characters, such as 150 characters. The “image_url” field is a hyperlink to an image corresponding to the profile for the search result record.

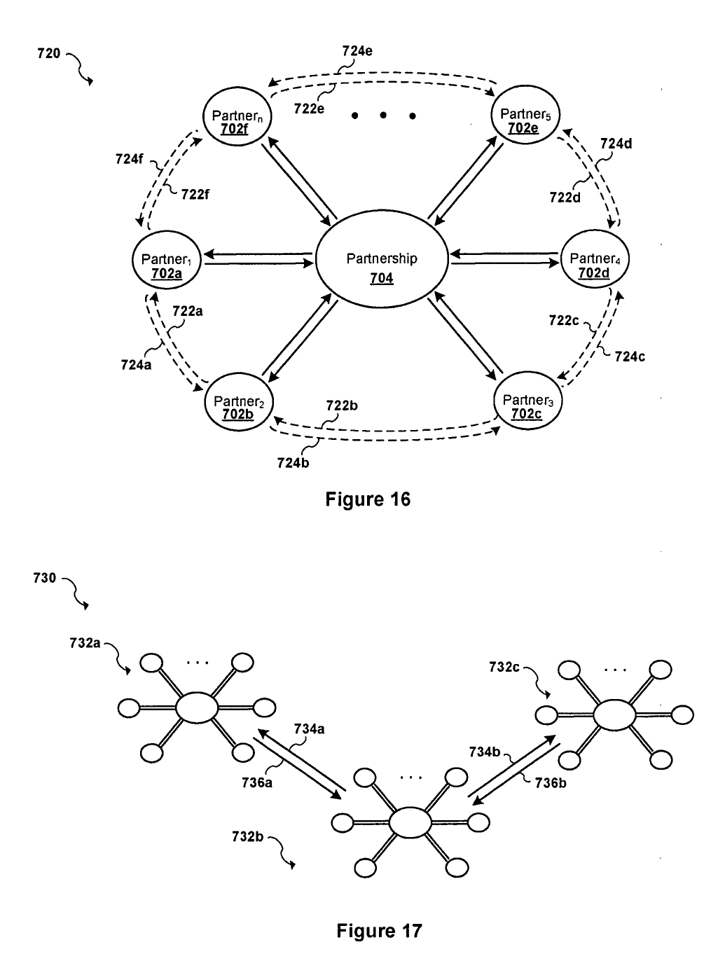

Referring to FIG. 16, a block diagram illustrating a collaborative relationship according to an optional embodiment of the present invention is shown. According to this embodiment, communications, such as the transmission of search requests and search responses, may occur directly between the one or more partner computer systems (702a-702f). For instance, partner computer system 702e may directly communicate with partner computer system 702c, such that at least a portion of the search is processed by partner computer system 702c instead of partner computer system 702e. Optionally, the partnership computer system 704 may facilitate this communication by providing communication information to the one or more partner computer systems (702, 702a-702f).

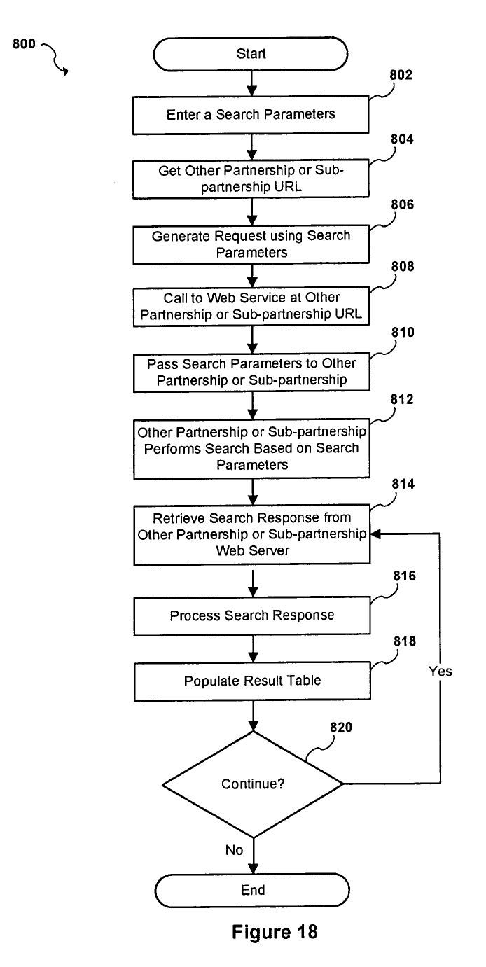

Referring to FIG. 17, a block diagram illustrating a collaborative relationship according to an optional embodiment of the present invention is shown. According to this embodiment, communications, such as the transmission of search requests and search responses, may occur between one or more partnerships (732a-732c), where each partnership (732a-732c) represents a partnership computer system 704 and one or more partner computer systems (702a-702f). For instance, partnership 732b may directly communicate with partnership 732a, such that at least a portion of the search is processed by partnership 732a instead of partnership 702b. Referring to FIG. 18, a flow chart illustrating the overall functionality for multiple partnerships and sub-partnerships according to an alternate embodiment of the present invention is shown. As shown at block 802, a user enters and/or selects one or more search parameters using a user interface. As shown at block 804, the URL of the web server of one or more other partnerships (732a-732c) or sub-partnership is retrieved from one or more databases 52. A search request, such as an XML file, is generated using the search parameters entered and/or selected by the user, as shown at block 806. In one optional embodiment, a web service is called on the partner computer system (702, 702a-702f) of the one or more other partnerships (732a-732c), as shown at block 808. After receiving the search request, the partner computer system (702, 702a-702f) of the one or more other partnerships (732a-732c) performs a search using the search parameters contained therein, as shown at block 810. The partner computer system (702, 702a-702f) of the one or more other partnerships (732a-732c) generates and populates a search response with the search results. The search response containing the search results is then transmitted to back to the partnership (732a-732c) that requested the search.

As shown at blocks 814 and 816, the search response is received by the partnership (732a-732c) that requested the search. The search results are populated into a result table, array, or the like, and displayed to the user via a user interface, as shown at block 818.

Blocks 814-818 continue until each of the search results are returned from the selected one or more partner computer systems (702, 702a-702f) of the one or more other partnerships (732a-732c), as shown at decision block 820. A timeout may also result in termination of blocks 814-818.

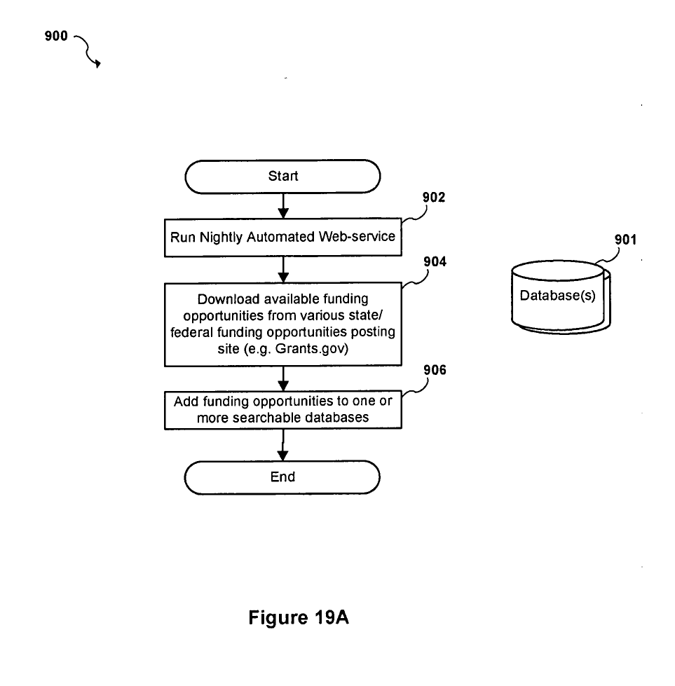

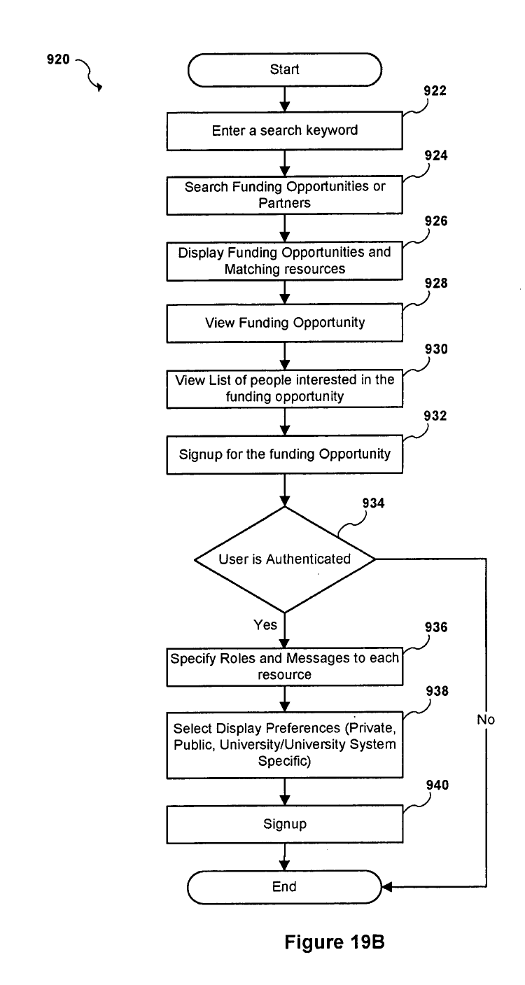

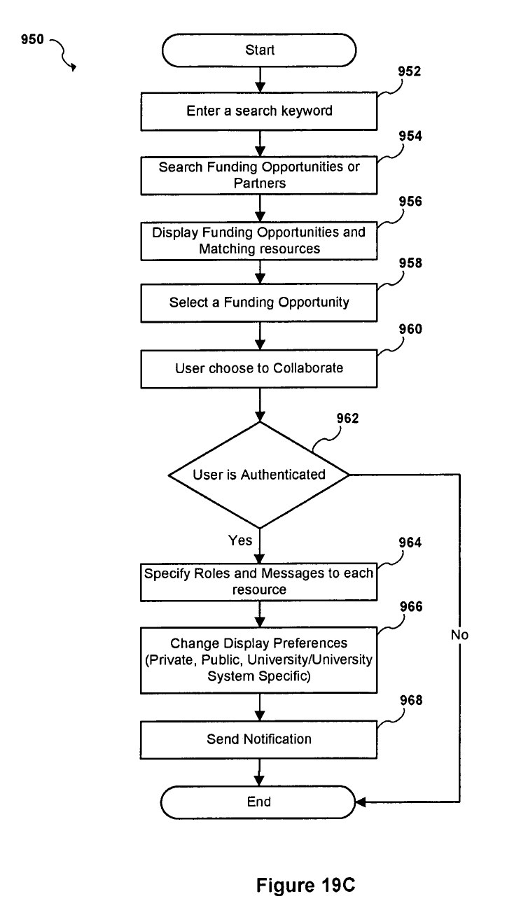

Referring to FIGS. 19A-19C, flow charts illustrating the overall functionality relating to funding opportunities according to an embodiment of the present invention are shown. According to this embodiment, a web service, such as .NET or the like, performs a nightly download of funding opportunities made available publicly on various federal/state funding opportunities listing websites (currently only grants.gov), as shown at blocks 902 and 904. As shown at block 906, the funding opportunities are added to one or more searchable databases 901. Optionally, various processes to categorize these funding opportunities into meaningful clusters is applied to the funding opportunities. The funding opportunities are then fully searchable by a user using keyword searches.

FIGS. 19B and 19C are flow charts illustrating an exemplary search mashup in which the partnership is utilized to perform to different types of searches in parallel allowing multiple different types of searches to be associated. For instance, as shown, the search mashup includes funding opportunities and expertise at institutions. A user may choose to enter a keyword, as shown at block 922, and perform a search of different types of data. For instance, the user may search for funding opportunities and expertise at institutions, as shown at blocks 924 and 925. The mashup search results are displayed to the user, as indicated at block 926. The user may interact with the different searches collectively or independently (i.e., view a funding opportunity and do a self signup for it). As shown at block 966, the present invention allows a user to set the details of what should be displayed in the public domain to other users viewing the funding opportunity. The user may also view more details of the search results. For instance, the user may choose to view a funding opportunity in more detail, as shown in blocks 928 and 930. As shown in blocks 960-968 of FIG. 19C, the user may also choose to create a connection between the different types of searches by selecting a single funding opportunity and selecting multiple resources and starting a collaborative working group. This may optionally include notifying the individuals identified as potential working group members. Such notification may be by any means known in the art, including, without limitation, by sending emails.

As shown in blocks 934 and 962, the user may be authenticated. Authentication may be performed by any means known in the art, including, without limitation, via remote authentication mechanisms (e.g., Shibboleth).

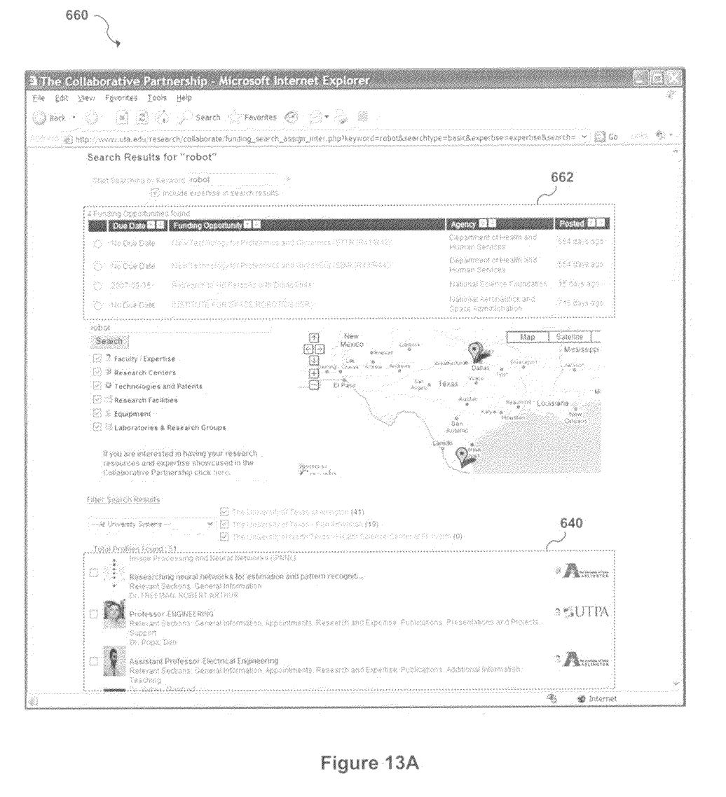

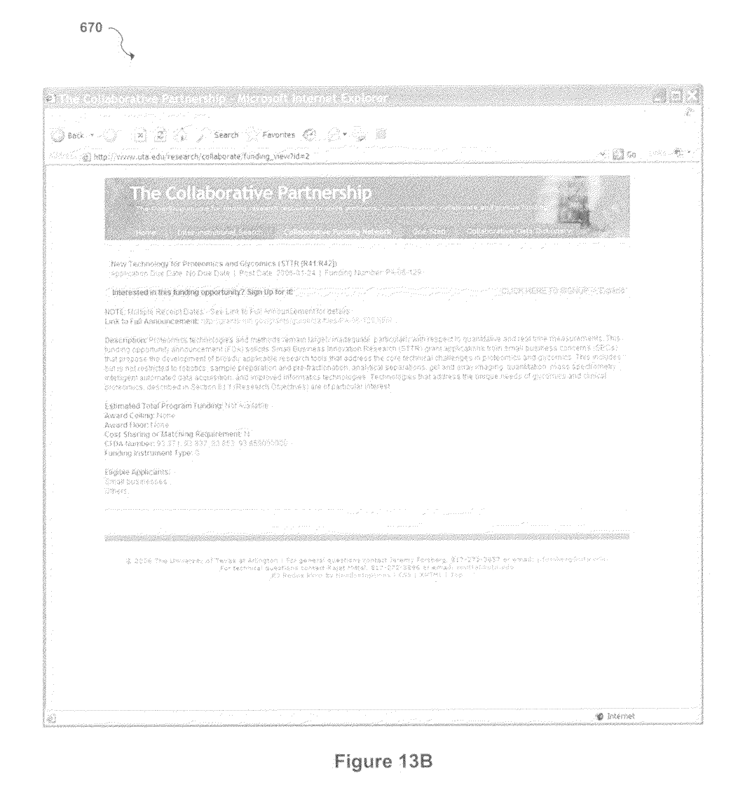

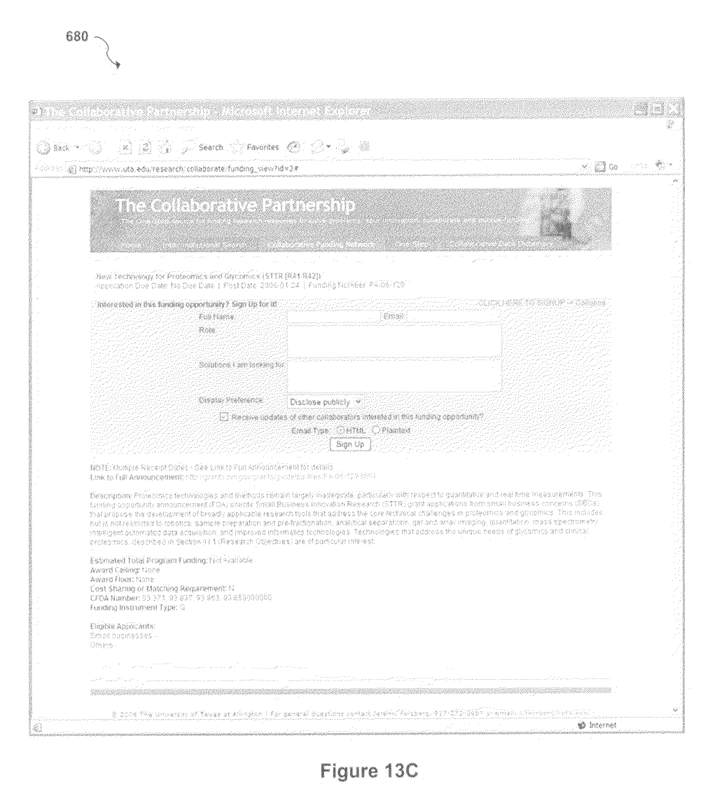

According to one possible non-limiting example, a user may choose to perform a mashup search for funding opportunities and expertise at institutions that relate to the keyword search “robot,” as shown in FIGS. 13A-13C. For instance, user interface 660 may be presented to the user which includes the expertise at institutions search results, based on the search parameters entered by the user, in search result area 640. The user interface 660 also includes funding opportunities search results, again based on the search parameters entered by the user, in search result area 662. Selecting one of the funding opportunities in search result area 662 results in detailed information about the funding opportunities being displayed to the user, as shown in FIG. 13B. As shown in FIG. 13C, user interface 680 may be displayed to the user if the user is interested in signing-up for a funding opportunity.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. For instance, it is to be understood that that the present invention is not intended to be limited to searching and may include other forms of collaborative possessing between a partnership computer system 704 and one or more partner computer systems (702a-702f). The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program embodied on a computer readable medium for collaboratively searching one or more distributed computer systems using a web-based user-interface on a computer system, wherein at least a portion of the search processing is remotely performed on the one or more distributed computer systems, the computer program comprising:
a first computer code for presenting a web-based user interface to a user, wherein the user interface includes one or more search parameters;
a second computer code for receiving one or more of the search parameters from the user interface;
a third computer code for generating a search request containing the received one or more search parameters;
a fourth computer code for transmitting the search request to at least one other computer system;
a fifth computer code for receiving a search response from the at least one other computer system containing one or more search results; and
a sixth computer code for displaying the search results on the user interface.

2. The computer program of claim 1, further comprising:
a seventh computer code for receiving the search request by the at least one other computer system from the computer system;
an eight computer code for processing the search request and producing the one or more search results by the at least one other computer system;
a ninth computer code for generating a search response containing the one or more search results by the at least one other computer system; and
a tenth computer code for transmitting the search response by the at least one other computer system to the computer system.

3. The computer program of claim 2, wherein the eight computer code comprises an eleventh computer code for searching a database on the at least one other computer system.

4. The computer program of claim 3, wherein the database is a relational database.

5. The computer program of claim 2, wherein the eight computer code comprises an eleventh computer code for searching at least one selected from the group consisting of a database, an ASCII file and a web page.

6. The computer program of claim 1, wherein the search request comprises an XML file having a plurality of XML tags.

7. The computer program of claim 6, wherein the search response comprises an XML file having a plurality of XML tags.

8. The computer program of claim 7, wherein the at least one other computer system comprises a plurality of computer systems.

9. The computer program of claim 7, wherein the search request is transmitted to a web server on the at least one other computer via a predefined URL.

10. The computer program of claim 9, further comprising a seventh computer code for searching a database for the URL.

11. The computer program of claim 8, further comprising a seventh computer code for calling a web service on the plurality of computer systems.

12. The computer program of claim 11, wherein the web service comprises AJAX connections with the plurality of computer systems.

13. The computer program of claim 12, further comprising:
an eight computer code for opening the AJAX connections; and
a ninth computer code for closing the AJAX connections.

14. The computer program of claim 11, further comprising an eighth computer code for merging the search results from at least two of the plurality of computer systems.

15. The computer program of claim 14, wherein the search results are merged by the relevance of the search results.

16. The computer program of claim 7, wherein the at least one other computer system searches one or more databases on the respective at least one other computer system.

17. The computer program of claim 7, wherein the at least one other computer system searches one or more web pages on the respective at least one other computer system.

18. The computer program of claim 17, wherein the one or more web pages on the at least one other computer system includes metadata, and the one or more web pages are searched on the at least one other computer system using metadata.

19. The computer program of claim 7, further comprising configuring the at least one other computer system to receive the search request, perform a search based on the search request and to transmit the search response containing the one or more search results.

20. The computer program of claim 2, wherein the eight computer code utilizes advanced filtering options.

21. A method for collaboratively searching one or more distributed computer systems using a web-based user-interface on a computer system, wherein at least a portion of the search processing is remotely performed on the one or more distributed computer systems, the method comprising:
presenting a web-based user interface to a user, wherein the user interface includes one or more search parameters;
receiving one or more of the search parameters from the user interface;
a third computer code for generating a search request containing the received one or more search parameters;
transmitting the search request to at least one other computer system;
receiving a search response from the at least one other computer system containing one or more search results from the another computer system; and
displaying the search results on the user interface.

22. The method of claim 21, further comprising:
receiving the search request by the at least one other computer system from the computer system;
processing the search request and producing the one or more search results by the at least one other computer system;
generating a search response containing the one or more search results by the at least one other computer system; and
transmitting the search response by the at least one other computer system to the computer system.

23. The method of claim 22, wherein the search request comprises an XML file having a plurality of XML tags.

24. The method of claim 23, wherein the search response comprises an XML file having a plurality of XML tags.

25. The method of claim 24, wherein the at least one other computer system comprises a plurality of computer systems.

26. The method of claim 25, further comprising calling a web service on the plurality of computer systems.

27. The method of claim 26, wherein the web service comprises AJAX connections with the plurality of computer systems.

28. The method of claim 25, further comprising merging the search results from at least two of the plurality of computer systems.

29. The method of claim 28, wherein the search results are merged by the relevance of the search results.
